(19) United States
(12) Patent Application Publication
(10) Pub. No.: US 2016/0230932 A1
(43) Pub. Date: Aug. 11, 2016

(54) LOW HEAT LOSS CRYOGENIC FLUID STORAGE EQUIPMENT USING MULTILAYERED CYLINDRICAL SUPPORT

(71) Applicants: University of Central Florida Research Foundation, Orlando, FL (US); Korea Institute of Science and Technology, Seoul (KR)

(72) Inventors: Jong Hoon Baik, Orlando, FL (US); Sarng Woo Karng, Seoul (KR); Seo Young Kim, Seoul (KR)

(21) Appl. No.: 14/690,005

(22) Filed: Apr. 17, 2015

(30) Foreign Application Priority Data
Feb. 5, 2015 (KR) 10-2015-0016991

(51) Int. Cl. F17C 13/00; F17C 3/02

(52) U.S. Cl. CPC F17C 13/001; F17C 3/02; F17C 2203/03; F17C 2221/033; F17C 2260/031

(57) ABSTRACT

A fluid storage device is provided having low heat-loss characteristics. The storage device may include an internal container for storing a cryogenic liquid and an external container at least partially surrounding the internal container. The storage device may include a cover enclosing an upper end of the external container and configured to maintain a vacuum around the inner container, as well as a transferring tube connected to the internal container to supply and/or extract the cryogenic liquid to/from the internal container. The storage device can also include a support structure coupled to both the cover and the internal container such that the internal container is suspended within the external container via the support structure. The support structure itself may include an inner cylindrical body coupled to the internal container and surrounding at least a portion of the internal container, an adjacent cylindrical body coupled to the inner cylindrical body, and an outer cylindrical body coupled to the adjacent cylindrical body. A plurality of coupling members may be disposed between the inner and adjacent cylindrical bodies and the adjacent and outer cylindrical bodies, respectively.

### CROSS-REFERENCE TO RELATED APPLICATION

This application claims priority to and the benefit of Korean Patent Application No. 10-2015-0016991, filed on Feb. 5, 2015, the disclosure of which is incorporated herein by reference in its entirety.

### BACKGROUND

The present invention relates to cryogenic fluid storage equipment, and more particularly, to low heat loss cryogenic fluid storage equipment using a multilayered cylindrical support, which minimizes a heat inflow from the outside and can store a cryogenic liquid such as liquefied natural gas (LNG), liquefied propane gas (LPG), liquid oxygen, liquid nitrogen, liquid hydrogen, liquid helium, and the like.

As the measure for solving problems of air pollution and global warming caused by excessive use of fossil fuel, research has focused on a system utilizing fuel sources other than hydrocarbon fuel. Hydrogen energy is one such fuel source.

In order to efficiently utilize hydrogen energy, a volume of the hydrogen may be reduced to make high density hydrogen. Using high density hydrogen results in superior storage, transport, and ease of use compared to lower density hydrogen. Of the various ways of storing hydrogen, liquefying and storing hydrogen in a liquid phase maintains the largest energy storage. Thus, to extend the utilization of hydrogen energy, cryogenic equipment is needed with the capability of effectively storing hydrogen in a liquid phase in a quick, safe, and effective manner.

An important aspect of storing a cryogenic liquid is providing a heat-insulation technique—in particular, a storage container—that can minimize evaporation caused by a heat inflow from external sources. Various methods of insulation have been utilized in the art. For example, vacuum insulation, multilayer insulation (MLI), and the like have been utilized. These methods of insulation can reduce conductive heat transfer, convective heat transfer, and radiant heat transfer caused by air.

However, improvements in storage containers for cryogenic liquids is still needed. For example, present containers still allow an undesired amount of heat transfer from the outside environment to the cryogenic liquid, which in the case of hydrogen, is typically stored at about −250° C. or below.

One drawback of typical cryogenic storage devices is that, for those containers utilizing an internal container within an external container, the internal container is fixed to a support structure that allows undesirable levels of heat transfer to the internal container. Thus, the support becomes a conductive heat transfer path from the outside to the cryogenic liquid. This, in turn, causes rapid evaporation of the stored cryogenic liquid.

### SUMMARY

The present disclosure is intended to solve the problems laid out above. For example, an object of the present disclosure is to provide a fluid storage device having low heat-loss characteristics. The storage device may include an internal container for storing a cryogenic liquid and an external container at least partially surrounding the internal container. The storage device may include a cover enclosing an upper end of the external container and configured to maintain a vacuum around the inner container, as well as a transferring tube connected to the internal container to supply and/or extract the cryogenic liquid to/from the internal container. The storage device can also include a support structure coupled to both the cover and the internal container such that the internal container is suspended within the external container via the support structure. The support structure itself may include an inner cylindrical body coupled to the internal container and surrounding at least a portion of the internal container, an adjacent cylindrical body coupled to the inner cylindrical body, and an outer cylindrical body coupled to the adjacent cylindrical body. A plurality of coupling members may be disposed between the inner and adjacent cylindrical bodies and the adjacent and outer cylindrical bodies, respectively.

Another object of the disclosure is to provide a thermal insulating structure. The thermal insulating structure can include an inner cylindrical body having a heat insulating material attached to a surface of the inner cylindrical body, an adjacent cylindrical body having a heat insulating material attached to a surface of the adjacent cylindrical body, the adjacent cylindrical body being spaced apart from and surrounding the inner cylindrical body, and an outer cylindrical body having a heat insulating material attached to a surface of the outer cylindrical body, the outer cylindrical body being spaced apart from and surrounding the adjacent cylindrical body. Additionally, the thermal insulating structure may include a first set of coupling members disposed between the inner and adjacent cylindrical bodies and coupling said cylindrical bodies to one another and a second set of coupling members disposed between the adjacent and outer cylindrical bodies and coupling said cylindrical bodies to one another.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a sectional perspective view of an example cryogenic fluid storage equipment.

FIG. 2 is a partial sectional perspective view of an example cryogenic fluid storage equipment.

FIG. 3 is a partial sectional perspective view of an example cryogenic fluid storage equipment.

FIG. 4 is a partial sectional view of an example multilayered cylindrical support of a cryogenic fluid storage equipment.

FIG. 5A is an exploded view showing a part of an example support in a cryogenic fluid storage device.

FIG. 5B is an exploded view showing a part of an example support in a cryogenic fluid storage device.

### DETAILED DESCRIPTION

Various cryogenic fluid storage devices are described in detail below with reference to the accompanying drawings. While the present disclosure is shown and described in connection with example embodiments thereof, it will be apparent to those skilled in the art that various modifications can be made without departing from the spirit and scope of the invention.

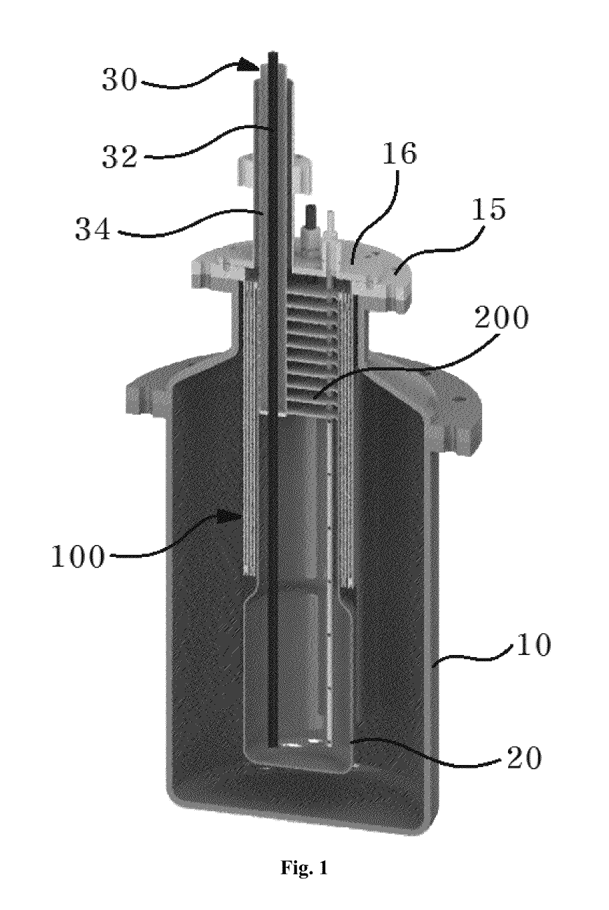

FIG. 1 shows an example cryogenic fluid storage device. The cryogenic fluid storage device of FIG. 1 includes an external container 10, an internal container 20 for storing a cryogenic fluid, and a transferring tube 30 for transferring cryogenic fluid into and/or out of the internal container 20. FIG. 1 also illustrates an example multilayered cylindrical support 100, and an example multilayered blocking plate 200.

The external container 10 may extend upward as shown in FIG. 1 and have an open upper end so that other elements such as the internal container 20 can be installed in the external container 10. An upper cover 15 is coupled with the open upper end. A through hole is formed on the upper cover 15, and the upper cover 15 includes a sealing plate 16 covering the through hole. In alternative embodiments, upper cover 15 and sealing plate 16 may be replaced by a single cover that seals the external container 10.

In the example embodiment of FIG. 1, the internal container 20 serves as a space in which a cryogenic fluid is actually stored, and the internal container 20 is installed in the external container 10 and spaced apart from an inner circumference surface of the external container 10. A vacuum may be formed in a space between the internal container 20 and the external container 10, and a vacuum heat insulating layer is may be included around the internal container 20 to increase the insulation of the cryogenic fluid. The vacuum between an inner circumference surface of the external container 10 and an outer circumference surface of the internal container 20 minimizes convective heat transfer and heat conduction caused by air.

Various heat insulating structures including a multilayered heat insulating material (not shown) surrounding the internal container 20 may be provided in the space between the external container 10 and the internal container 20. For example, the space between containers may be filled with an insulating material that is also in a vacuum.

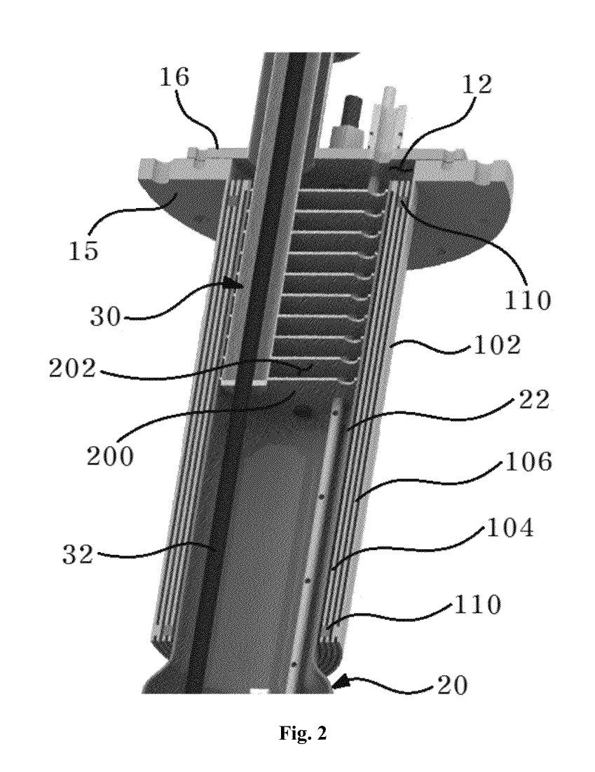

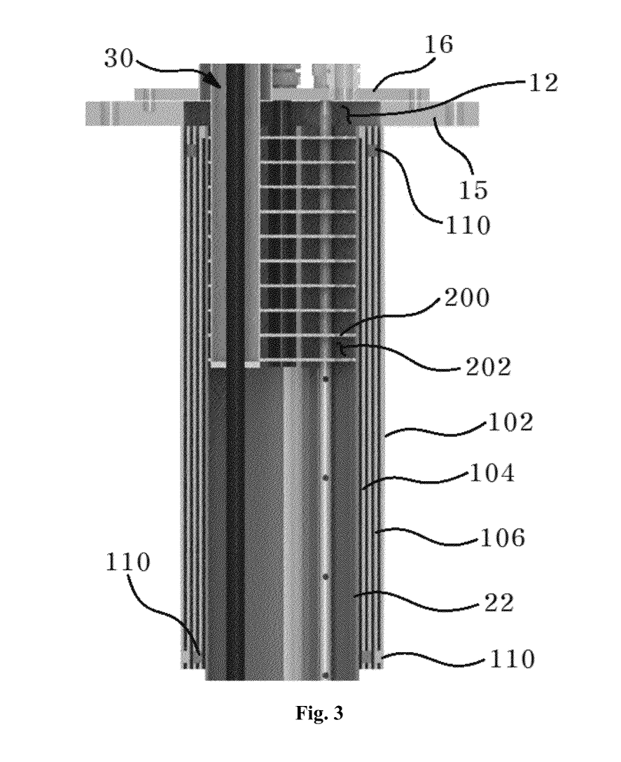

The internal container 20 may include a neck portion (shown in FIG. 2 as 22) which extends from a cryogenic liquid filling space formed at a lower portion to an upper portion. Various elements may extend through the neck portion and into the internal container 20, such as the transferring tube 30 for transferring a cryogenic liquid and a level-measuring tube for measuring an amount of stored cryogenic liquid. A multilayered blocking plate 200 may also be installed within the neck portion of the internal container 20. The multilayered blocking plate 200 can be used to interrupt an upward movement of boiled-off gas toward an upper end of the internal container 20, thereby preventing unwanted heat transfer.

FIG. 1 shows the internal container 20 suspended from multilayered support 100, which is in turn suspended from upper cover 15. In other embodiments, multilayered support 100 may suspend internal container 20 by attaching to the external container 10 rather than upper cover 15.

The transferring tube 30 is connected to the internal container 20 to fill and extract a cryogenic liquid. A filling tube and a discharging tube may be separately formed. In the embodiment of FIG. 1, the transferring tube 30 includes an inner tube 32 through which a cryogenic liquid is moved and an outer tube 34 surrounding at least a portion of the inner tube 32. A vacuum may be formed between the inner tube 32 and the outer tube 34 to block convective heat transfer and heat conduction otherwise caused by air.

The transferring tube 30 may penetrate either, or both, the sealing plate 16 and the upper cover 15. It can also penetrate the various levels of multilayered blocking plate 200. The outer tube 34 is extended to a location adjacent to a lower end of the neck portion 22, and the inner tube 32 is extended to a lower end of a main body of the internal container 20. The outer tube 34 may be extended a shorter or longer distance along inner tube 32, based on the necessity for insulation along inner tube 32.

As shown in FIG. 2, the multilayered cylindrical support 100 includes at least one cylindrical support body surrounding at least a portion of neck portion 22 of internal container 20. In some embodiments, multilayered cylindrical support 100 includes a multilayered structure in which an inner cylindrical body is spaced apart from another adjacent outer cylindrical body and the outer cylindrical body surrounds the adjacent inner cylindrical body.

Among the cylindrical bodies constituting the multilayered cylindrical support 100, an outermost cylindrical body 102 is attached to a periphery of the through hole 12 under the upper end cover 15 through an upper end thereof and is extended downward to surround the neck portion 22. The outermost cylindrical body 102 may be formed integrally with the upper end cover 15 at the time of manufacturing the same.

Among the cylindrical bodies constituting the multilayered cylindrical support 100, an innermost cylindrical body 104 is attached to an upper end of the internal container 20, that is, to an outer circumference surface of an upper end of the neck portion 22 through an upper end thereof, and the innermost cylindrical body is spaced apart from the neck portion 22 and is extended downward to surround the neck portion 22.

A plurality of intermediate cylindrical bodies 106 are further provided between the outermost cylindrical body 102 and the innermost cylindrical body 104, and the cylindrical bodies 102, 104, 106 are spaced apart from each other with a certain space. Although the accompanying drawing shows that the multilayered cylindrical support 100 according to the embodiment of the present invention has a multilayered structure in which a space is formed between two adjacent bodies of four (4) cylindrical bodies 102, 104, and 106, the present disclosure is not limited to the number of the cylindrical bodies. For example, the multilayered cylindrical support 100 may include only one cylindrical body, or may include 6, 8, 10, or more cylindrical bodies.

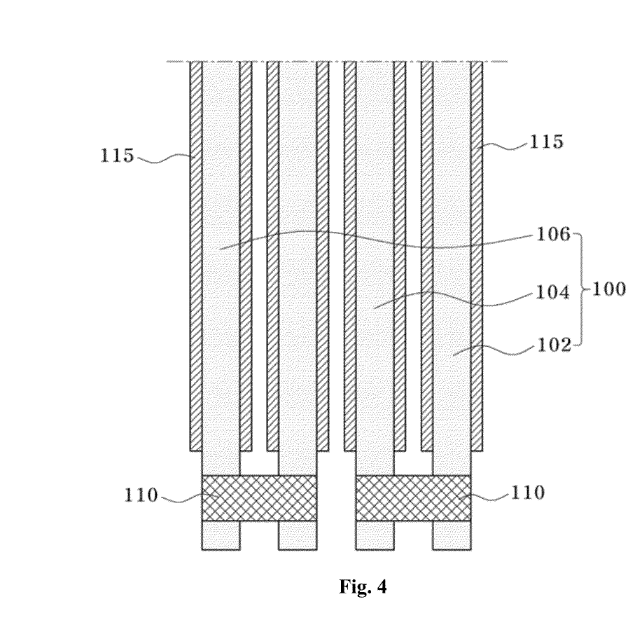

In an example embodiment, a heat insulating material, preferably, a multilayered heat insulating material 115 may be attached to both surfaces of each of the cylindrical bodies 102, 104, and 106 constituting the multilayered cylindrical support (see FIG. 4). Here, the multilayered heat insulating material 115 may be attached by means of an extremely low temperature adhesive. The multilayered heat insulating material 115 attached to one cylindrical body is spaced apart from the multilayered heat insulating material 115 attached to another adjacent cylindrical body.

In the example embodiment of FIG. 2, the multilayered cylindrical support 100 includes a coupling member 110 for coupling the cylindrical bodies 102, 104, and 106, which are adjacent to each other and constitute the multilayered cylindrical support 100, in a state where the cylindrical bodies are spaced apart from each other. Due to the above structure, the multilayered cylindrical support 100 supports the internal container 20 with respect to the upper end cover 15 of the external container 10.

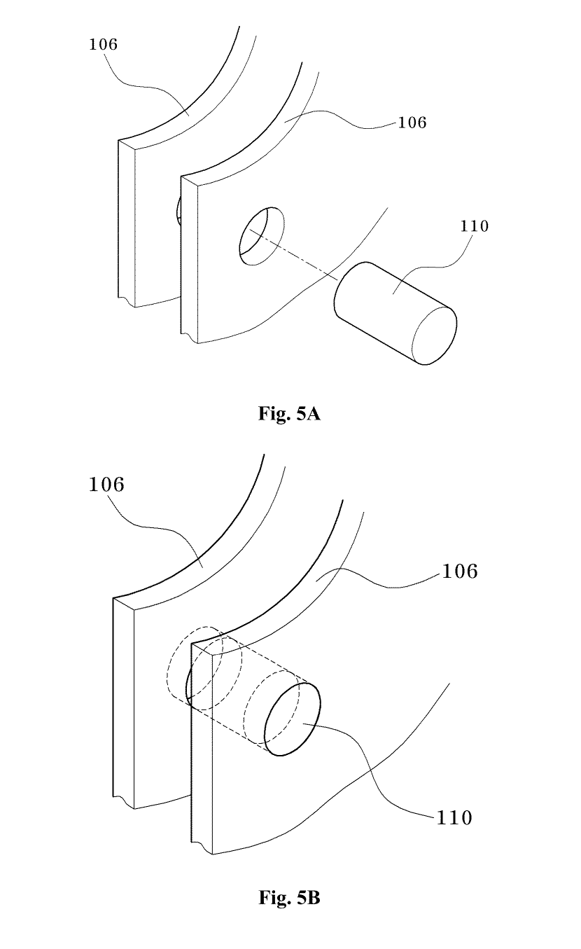

FIGS. 5A and 5B show an example embodiment of a coupling member 110 coupling two adjacent intermediate cylindrical bodies 106 to one another. A similar type of coupling may be used between the adjacent cylindrical bodies 102, 104, and 106 of, for example, FIG. 2. Referring to FIG. 5, through holes are formed on main surfaces of the cylindrical bodies 106, which are faced to each other, and both end portions of the coupling member 110 are inserted in the through holes.

In the embodiment of FIG. 5, the coupling member 110 has a thickness greater than the sum of thicknesses of both cylindrical bodies. In this embodiment, the length of the coupling member 110 retains a space between adjacent cylindrical bodies 106. For example, the coupling member may have a cylindrical block shape having a thickness of several millimeters. The coupling member 110 couples the adjacent cylindrical bodies 102, 104, and 106 in a state where the cylindrical bodies are spaced apart from each other, to allow the cylindrical bodies to be supported with respect to each other.

Coupling members 110 may be sized such that the friction generated between the coupling member 110 and the hole cause the coupling member 110 to remain in the hole and couple the adjacent cylindrical bodies to one another. In that embodiment, coupling members 110 may be installed via press fitting. In other embodiments, coupling members 110 may have keyholes or other suitable mechanisms for locking into place.

According to one embodiment, the cylindrical bodies which are adjacent to each other include at least three coupling members 110 arranged in regular intervals. However, the present invention is not limited by the size and number of the coupling members. For example, if the cryogenic fluid storage equipment has a large capacity, that is, if the block type coupling member is not sufficient to support a weight of the internal container, partial ring-shaped block type coupling members disposed between the adjacent cylindrical bodies 102, 104, and 106 may be employed as the coupling member to support the adjacent cylindrical bodies 102, 104, and 106. The coupling member 110 is designed such that the coupling member supports a weight exerted between the adjacent cylindrical bodies 102, 104, and 106 and minimizes a heat-conduction area.

As shown in FIG. 2, in the coupling members 110 of the multilayered cylindrical support 100, the cylindrical bodies are placed in the spaces adjacent to each other in a radial direction and are alternately arranged at an upper portion and a lower portion to couple the adjacent cylindrical bodies. For example, the outermost cylindrical body 102 and the adjacent intermediate cylindrical body 106 are coupled at a lower portion by the coupling member 110, the intermediate cylindrical body 106 and another adjacent inside intermediate cylindrical body 106 are coupled at an upper portion by the coupling member 110, and the inside intermediate cylindrical body 106 and the adjacent innermost cylindrical body 104 are coupled at a lower portion by the coupling member 110. The arrangement in which the coupling members 110 are placed in the spaces which are adjacent to each other in the radial direction increases a heat conduction length—that is, the length of material through which heat conduction must travel.

In addition, the coupling members 110 of the multilayered cylindrical support 100 according to the present invention are arranged such that the coupling members placed in the spaces which are adjacent to each other in the radial direction are disposed in a circumferential direction in a zigzag shape. In other words, if the coupling members 110 are arranged at angular locations of 0°, 120°, and 240° between the outermost cylindrical body 102 and the adjacent intermediate cylindrical body 106, the coupling members 110 placed in the spaces (which are adjacent to each other in the radial direction) between the other intermediate cylindrical body 106 and the innermost cylindrical body 104 are arranged at angular locations of 60°, 180°, and 300°. Due to the arrangement of the above coupling members 110, it is possible to further extend the heat conduction length. Other angular locations are also contemplated, especially in situations where additional coupling members 110 are utilized.

According to an example embodiment, the coupling member 110 is formed of a low heat-conductive material. For example, coupling member 110 may be formed of GREL (glass reinforced epoxy laminate). GREL includes, for example, G-10, G-11, and G-10 CR. More preferably, G-10 CR (fiberglass epoxy for cryogenic use) may be employed as a material used for forming the coupling member. G-10 CR is advantageous in that the heat-conductivity of G-10 CR at an extremely low temperature is very low, a displacement of heat contraction and heat expansion of G-10 CR is small, and G-10 CR can effectively reduce heat conduction between a low temperature of the internal container and room temperature of the outside. The coupling member 110 formed of GREL satisfies a mechanical strength so as to couple and support the cylindrical bodies and minimizes the heat conduction through a low heat conduction property.

Due to the above structure, the multilayered cylindrical support 100 of the present invention can simultaneously perform the functions of supporting the internal container 20 with respect to the external container 10, reducing a radiant heat transfer, and minimizing heat conduction. Because heat conduction indicates that heat is transferred along/through an object, the rate of heat conduction can be controlled by adjusting the length of a heat transferring path and an area of the heat transferring path.

Since the cylindrical body 102, 104, or 106 and the adjacent cylindrical body 102, 104, or 106 are coupled with each other through the coupling member 110, the heat conduction between the cylindrical body 102, 104, or 106 and the adjacent cylindrical body 102, 104, or 106 necessarily passes through the coupling member 110. As compared with the cylindrical bodies 102, 104, and 106, however, the coupling member 110 has a very small heat conduction area, and thus a so-called “thermal bottleneck” phenomenon is generated and heat conducted through the coupling member 110 is minimized. In addition, since the multilayered cylindrical support 100 has the multilayered structure of the cylindrical bodies spaced from each other, conducted heat is reduced whenever the heat passes through the coupling members 110. Thus, when seen from the innermost cylindrical body 104, it is possible to minimize inflow heat conducted from outside room temperature.

In some embodiments, the coupling members 110 alternately couple the adjacent cylindrical bodies at an upper portion and a lower portion and are disposed in the circumferential direction in the zigzag shape. Heat conducted from the upper cover 15 exposed to an external room temperature to the outermost cylindrical body 102 is transferred to a lower portion along the longest path of the cylindrical body 102, and is then conducted to the adjacent intermediate cylindrical body 106 through the coupling member 110 placed at the lower portion. The heat conducted to the intermediate cylindrical body 106 is transferred to the upper portion along a path which is the same as the above path, and is conducted to the other inside intermediate cylindrical body 106 through the coupling member 110 connecting the other inside intermediate cylindrical body 106 to this intermediate cylindrical body. In other words, a heat conduction path which is longer than the sum of lengths of the cylindrical bodies is formed. Thus, according to the present invention, it is possible to minimize the heat conduction due to a kind of the thermal bottleneck phenomenon and an extension of the heat conduction caused by the coupling member 110. In addition, if the coupling member 110 is formed of a GREL material, the heat conduction is further minimized. Simultaneously, since the multilayered heat insulating material 115 is disposed between the cylindrical bodies 102, 104, and 106, it is possible to minimize the radiant heat transfer.

In some embodiments, blocking plates 200 are provided in multiple layers in the neck portion 22 of the internal container 20. The blocking plates 200 block the neck portion 22 in a transverse direction which is perpendicular to the extension direction of the neck portion 22, and the blocking plates are formed in a multilayered structure in which the blocking plates are spaced apart from each other to form a space 202 therebetween. Blocking plates 200 may be formed of a GREL material which is a kind of a low heat-conductive material, and preferably, G-10 CR may be utilized as the material for the blocking plate.

The multilayered blocking plates 200 prevent, among other things, convective heat transfer in which a gas produced by evaporating a cryogenic fluid in the internal container 20 is moved to an upper portion of the internal container 20. Since the transferring tube 30 penetrates the multilayered blocking plates 200, some of evaporated gas is moved upward along a space between an outer circumferential surface of the transferring tube 30 and an inner circumferential surface of the hole of each blocking plate 200 through which the transferring tube 300 passes, that is, along a portion through which the transferring tube 300 passes, and can be then moved to the space 202 between the blocking plates 200. However, since the blocking plates are provided in a multilayered structure, the spaces 202 formed between the blocking plates 200 are also disposed in a multilayered structure.

In other words, since a flow of gas in the space 202 placed on and under the blocking plate 202 is maximally suppressed, and the spaces 202 are disposed in the multilayered structure to maximally suppress the flow of gas, the convective heat transfer caused by the flow of gas can be minimized.

In addition, since the blocking plate 200 is formed of a low heat-conductive material, for example, a GREL material, the heat conduction between the upper and lower spaces 202 is suppressed so that the multilayered blocking plates 200 can effectively prevent heat invasion from the outside into the internal container 20.

Various modifications can be made to the above-described example embodiments without departing from the spirit or scope of the invention. Thus, it is intended that the present invention covers all such modifications.

What is claimed is:

1. A cryogenic fluid storage device, comprising:
an internal container for storing a cryogenic liquid;
an external container at least partially surrounding the internal container;
a cover enclosing an upper end of the external container and configured to maintain a vacuum around the inner container;
a transferring tube connected to the internal container to supply and/or extract the cryogenic liquid to/from the internal container;
a support structure coupled to both the cover and the internal container such that the internal container is suspended within the external container via the support structure;
wherein the support structure comprises:
an inner cylindrical body coupled to the internal container and surrounding at least a portion of the internal container;
an adjacent cylindrical body coupled to the inner cylindrical body;
an outer cylindrical body coupled to the adjacent cylindrical body; and
a plurality of coupling members disposed between the inner and adjacent cylindrical bodies and the adjacent and outer cylindrical bodies, respectively.

2. The cryogenic fluid storage device of claim 1, wherein the inner, adjacent, and outer cylindrical bodies are spaced apart from one another.

3. The cryogenic fluid storage device of claim 1, wherein at least two of the plurality of coupling members are disposed between the cylindrical bodies in different locations along a longitudinal axis of the internal container, relative to one another.

4. The cryogenic fluid storage device of claim 3, wherein the plurality of coupling members are disposed between the cylindrical bodies in an alternating pattern.

5. The cryogenic fluid storage device of claim 4, wherein the plurality of coupling members are disposed between the cylindrical bodies in a zigzag pattern.

5. The cryogenic fluid storage device of claim 5, wherein coupling members of a first group of the plurality of coupling members are arranged at angular increments of 120° with respect to the longitudinal axis.

6. The cryogenic fluid storage device of claim 1, wherein the plurality of coupling members comprise a low heat-conductive material and/or GREL (glass reinforced epoxy laminate) material.

7. The cryogenic fluid storage device of claim 1, wherein at least one cylindrical body comprises at least one hole through which at least one of the plurality of coupling members may be inserted to operatively couple the coupling member to at least one cylindrical body.

8. The cryogenic fluid storage device of claim 7, wherein at least two cylindrical bodies comprise at least one hole each, located such that at least one of the plurality of coupling members may be inserted through both of the at least one holes in order to couple the at least two cylindrical bodies to one another.

9. The cryogenic fluid storage device of claim 7, wherein the at least one hole is formed in the shape of a rectangle, and wherein the at least one coupling member is shaped to fit within the at least one hole.

10. The cryogenic fluid storage device of claim 1, wherein at least one cylindrical body comprises a heat insulating material attached to a surface of the at least one cylindrical body.

11. The cryogenic fluid storage device of claim 1, wherein the internal container comprises:
a neck portion, through which the transferring tube passes; and
a plurality of blocking plates disposed within the neck portion and arranged perpendicular to a longitudinal axis of the internal container, the plurality of blocking plates being spaced apart from one another, wherein the transferring tube passes through each of the plurality of blocking plates.

12. The cryogenic fluid storage device of claim 1, wherein the plurality of blocking plates comprise a low heat-conductive material and/or GREL material.

13. A thermal insulating structure, comprising:
an inner cylindrical body having a heat insulating material attached to a surface of the inner cylindrical body;
an adjacent cylindrical body having a heat insulating material attached to a surface of the adjacent cylindrical body, the adjacent cylindrical body being spaced apart from and surrounding the inner cylindrical body;
an outer cylindrical body having a heat insulating material attached to a surface of the outer cylindrical body, the outer cylindrical body being spaced apart from and surrounding the adjacent cylindrical body;
a first set of coupling members disposed between the inner and adjacent cylindrical bodies and coupling said cylindrical bodies to one another;
a second set of coupling members disposed between the adjacent and outer cylindrical bodies and coupling said cylindrical bodies to one another;
wherein the first and second sets of coupling members comprise a low heat-conductive material and/or GREL material.

14. The thermal insulating structure of claim 13, wherein the plurality of coupling members are disposed between the cylindrical bodies in an alternating pattern.

15. The thermal insulating structure of claim 13, wherein the inner, adjacent, and outer cylindrical bodies comprise at least one hole each, the holes shaped to accept one coupling member.

16. The thermal insulating structure of claim 15, wherein the holes of the cylindrical bodies are aligned such that one coupling member may be inserted through corresponding holes of cylindrical bodies.

17. The thermal insulating structure of claim 13, wherein said structure is shaped to fit around a cryogenic fluid storage device.

18. The thermal insulating structure of claim 13, wherein said structure is configured to operatively couple an internal container to an external container.

19. The thermal insulating structure of claim 18, wherein the inner cylindrical body is operatively coupled to the internal container and the outer cylindrical body is operatively coupled to the external container.

20. The thermal insulating structure of claim 18, wherein the inner cylindrical body is operatively coupled to the internal container and the outer cylindrical body is operatively coupled to a lid enclosing the internal container.
